(19) United States
(12) Patent Application Publication
(10) Pub. No.: US 2005/0072289 A1
(43) Pub. Date: Apr. 7, 2005

(54) String retainer for musical instruments

(76) Inventor: Kelly M. Butler, Natick, MA (US)

Correspondence Address: John E. Toupal, 116 Concord Street, Framingham, MA, 01702, US

(21) Appl. No.: 10/674,705

(22) Filed: Oct. 1, 2003

(51) Int. Cl. G10D 3/14

(52) U.S. Cl. 84/312 R

(57) ABSTRACT

A stringed instrument including a body having a front surface and a rear surface, a tuning mechanism, and a neck having one end joined to the body and an opposite end retaining the tuning mechanism. A retainer block is encompassed by the rear surface and a plurality of strings each has a first end secured to the tuning mechanism and a second end retained by the retainer block.

### BACKGROUND OF THE INVENTION

This invention relates generally to stringed musical instruments and, more particularly, to a retainer and positioning arrangement for the strings of such instruments.

Traditional stringed instruments employ a plurality of strings which can be strummed to produce desired tonal sounds. Typically, the strings are fed between tuning screws mounted on a neck of the instrument and either ferrules retained by a rear surface of the instrument's body or a block mounted on a front surface thereof. Individual ferrules are undesirably subject to separation from the body upon breakage of an attached string while block string retainers retained on the instrument's front surface produce a different tonal quality.

The object of this invention, therefore, is to provide a stringed instrument offering improved tonal output and ease of use.

### SUMMARY OF THE INVENTION

The invention is a stringed instrument including a body having a front surface and a rear surface, a tuning mechanism, and a neck having one end joined to the body and an opposite end retaining the tuning mechanism. Also included is a retainer block encompassed by the rear surface and a plurality of strings each having a first end secured to the tuning mechanism and a second end retained by the retainer block. The string retainer block disposed at the rear surface of the body enhances tonal performance of the instrument.

According to certain features of the invention, the instrument includes a bridge mounted on the front surface, the retainer block has an inner surface and an outer surface and defines a plurality of channels extending between the inner and outer surfaces, and each of the strings extends from the tuning mechanism over the bridge and through a different one of the channels. The bridge and channels form desired feed paths for the strings.

According to other features of the invention, the second ends are enlarged to prevent passage through the channels which have counterbores in the outer surface retaining the enlarged second ends. These features provide efficient retention of the strings by the retainer block.

According to an additional feature of the invention, the block is unitary and made of brass. The provision of a unitary brass block further enhances tonal performance of the instrument.

According to yet another feature of the invention, the body defines a cavity retaining the block and intersecting the rear surface. Retaining the block in a cavity enhances user friendliness of the instrument by eliminating an undesirable obstruction on the rear surface of the body.

### DESCRIPTION OF THE DRAWINGS

These and other objects and features of the invention will become more apparent upon a perusal of the following description taken in conjunction with the accompanying drawings wherein:

FIG. 1 is a top view of a stringed musical instrument according to the invention;

FIG. 2 is a bottom perspective view of the instrument shown in FIG. 1;

FIG. 3 is a partially broken away side view of the instrument shown in FIGS. 1 and 2;

FIG. 4 is a detailed sectional view of a string retainer arrangement of the instrument shown in FIGS. 1-3;

FIG. 5 is a top perspective view of a string retainer block used in the arrangement of FIG. 4;

FIG. 6 is a top view of the retainer block shown in FIG. 5; and

FIG. 7 is a sectional view of the retainer block shown in FIGS. 5 and 6.

### DESCRIPTION OF THE PREFERRED EMBODIMENT

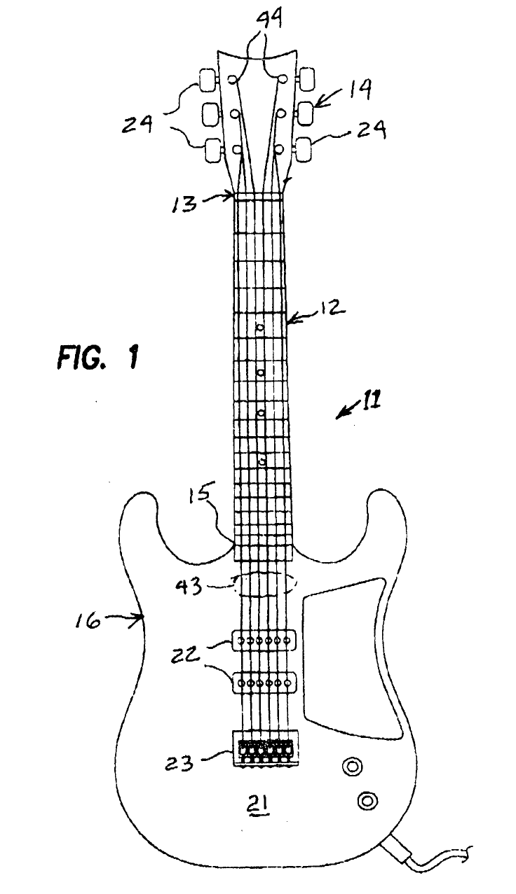

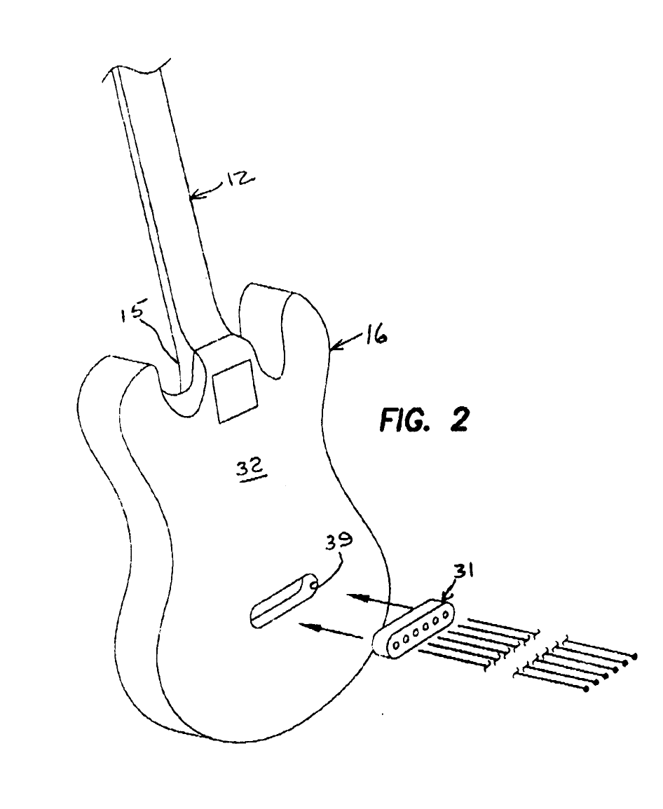

A stringed instrument 11 includes a neck 12 having one end 13 secured to a tuning mechanism 14 and an opposite end 15 secured to a body 16 as shown in FIGS. 1 and 2. Mounted on a front surface 21 of the body 16 are pickups 22 and a bridge 23. The tuning mechanism 14 includes a plurality of tuning screws 24.

As depicted in FIGS. 2-4, a retainer block 31 is mounted on the body 16 and encompassed by a rear surface 32 thereof. The block 31 defines a plurality of cylindrical parallel passages 34 arranged in a linear array and extending between an inner surface 36 and an outer surface 37. Counterbore portions 38 of the passages 34 are formed in the outer surface 37 of the block 31. Preferably, the block 31 is made of brass and as shown in FIG. 4 is retained in a cavity 39 defined by the body 16 and intersecting the rear surface 32 thereof.

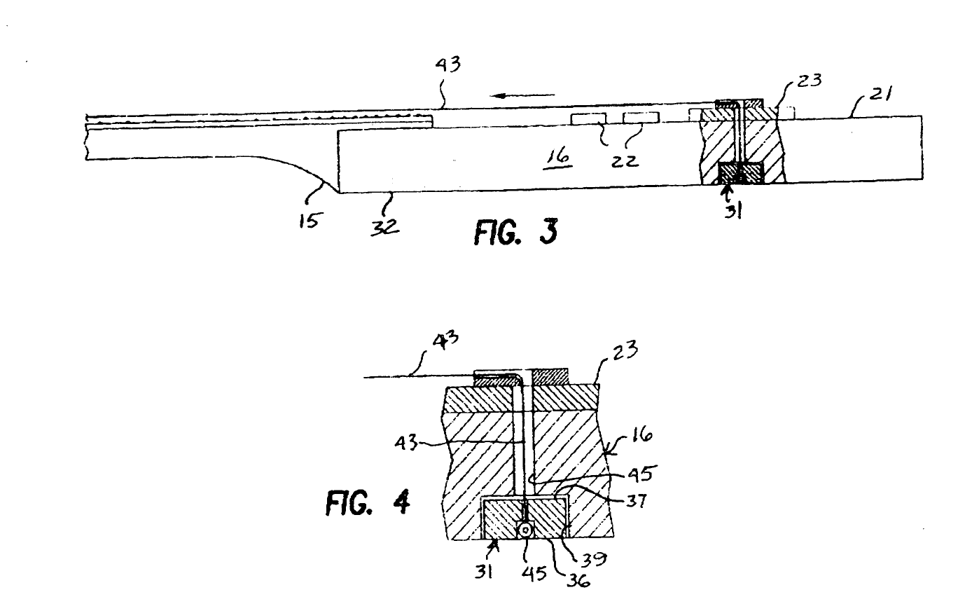

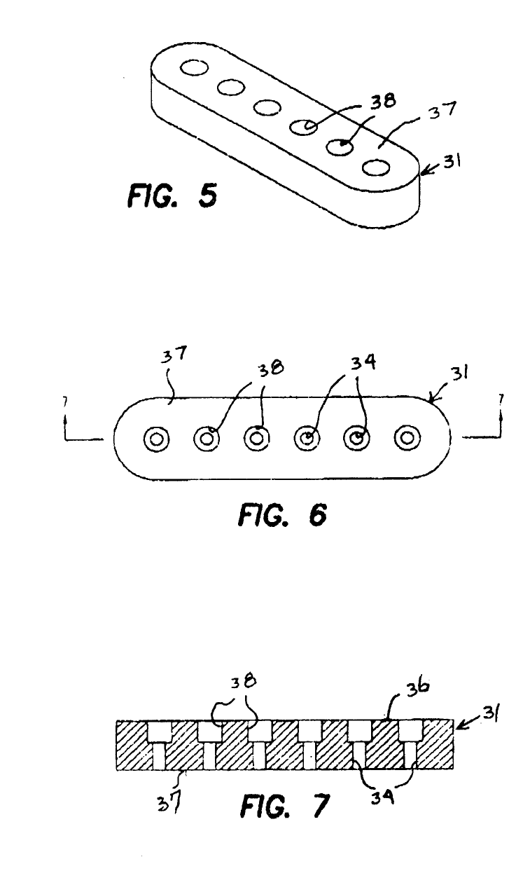

The instrument 11 includes a plurality of strings 43 which can be strummed in a conventional manner to produce sound. Each of the strings 43 has a first end 44 secured to a different one of the tuning screws 24 (FIG. 1) and a second end 45 retained by a different counterbore 38 of the block 31 (FIGS. 3 and 4). The second ends 45 are formed by enlarged balls so as to prevent their passage through the channels 34. Between the tuning mechanism 14 and the block 31 the strings pass over the pickups 22 and are diverted by the bridge 23 through a slot 45 extending into the body 16 and intersecting the cavity 39.

During use of the instrument 11, the tuning screws 24 are used to tighten the strings 43 to a degree desired to produce desired tonal sound output in response to strumming. The tonal output of the strummed strings 43 is enhanced by their passage through the body 16 and termination in the unitary brass block 31. In addition, the block 31 is not subject to separation from the body 16 if one of the strings 43 is broken. In that event, the block is retained in the cavity 39 by the remaining attached strings.

Obviously, many modifications and variations of the present invention are possible in light of the above teaching. It is to be understood, therefore, that the invention can be practiced otherwise than as specifically described.

1. A stringed instrument comprising:
a body having a front surface and a rear surface;
a tuning mechanism;
a neck having one end joined to said body and an opposite end retaining said tuning mechanism;
a retainer block encompassed by said rear surface; and
a plurality of strings each having a first end secured to said tuning mechanism; and a second end retained by said retainer block.

2. A stringed instrument according to claim 1 including a bridge mounted on said front surface and wherein said strings extend from said tuning mechanism, over said bridge, and through said body to said block.

3. A stringed instrument according to claim 2 wherein said retainer block has an inner surface and an outer surface and defines a plurality of channels extending between said inner and outer surfaces, and each of said strings passes through a different one of said channels.

4. A stringed instrument according to claim 3 wherein said second ends are enlarged to prevent passage through said channels.

5. A stringed instrument according to claim 4 wherein each of said channels comprises a counterbore in said outer surface retaining one of said enlarged second ends.

6. A stringed instrument according to claim 1 wherein said block is unitary and made of brass.

7. A stringed instrument according to claim 6 including a bridge mounted on said front surface and wherein said strings extend from said tuning mechanism, over said bridge, and through said body to said block.

8. A stringed instrument according to claim 7 wherein said retainer block has an inner surface and an outer surface and defines a plurality of channels extending between said inner and outer surfaces, each of said strings passes through a different one of said channels.

9. A stringed instrument according to claim 8 wherein said second ends are enlarged to prevent passage through said channels.

10. A stringed instrument according to claim 9 wherein each of said channels comprises a counterbore in said outer surface retaining one of said enlarged second ends.

11. A stringed instrument according to claim 3 wherein said body defines a cavity retaining said block and intersecting said rear surface.

12. A stringed instrument according to claim 11 wherein said second ends are enlarged to prevent passage through said channels.

13. A stringed instrument according to claim 12 wherein each of said channels comprises a counterbore in said outer surface retaining one of said enlarged second ends.

14. A stringed instrument according to claim 11 wherein said block is unitary and made of brass.

15. A stringed instrument according to claim 14 wherein said second ends are enlarged to prevent passage through said channels.

16. A stringed instrument according to claim 15 wherein each of said channels comprises a counterbore in said outer surface retaining one of said enlarged second ends.
